(19) United States
(12) Patent Application Publication
(10) Pub. No.: US 2014/0241737 A1
(43) Pub. Date: Aug. 28, 2014

(54) SHEET PROCESSING APPARATUS, IMAGE FORMING SYSTEM, AND SHEET PROCESSING CONTROL METHOD

(71) Applicant: KONICA MINOLTA, INC., Tokyo (JP)

(72) Inventor: Satoru SHIRASAKA, Tokyo (JP)

(73) Assignee: KONICA MINOLTA, INC., Tokyo (JP)

(21) Appl. No.: 14/187,092

(22) Filed: Feb. 21, 2014

(30) Foreign Application Priority Data
Feb. 22, 2013 (JP) 2013-032849

(51) Int. Cl. G03G 15/00; B65H 31/24

(52) U.S. Cl. CPC G03G 15/6552; G03G 15/6573; G03G 15/70; B65H 31/24
USPC 399/20; 271/288

(57) ABSTRACT

When performing a purging process in which remaining sheets remaining in the image forming system are gathered and ejected to any of trays in an ejection section, any of the trays other than a valid sheet tray to which a sheet having a normally formed imager has been ejected is set as a purge tray which is a tray to which the remaining sheets are to be ejected by the purging process, and the ejection section is controlled to eject the remaining sheet to such purge tray

This application claims priority under 35 U.S.C. §119 to Japanese Patent Application No. 2013-32849 filed on Feb. 22, 2013, the entire disclosure of which is incorporated herein by reference in its entirety.

### BACKGROUND OF THE INVENTION

1. Field of the Invention

The present invention relates to a sheet processing apparatus connected to an image forming apparatus, an image forming system to which an image forming apparatus and a sheet processing apparatus are connected, or a sheet processing control method for controlling a sheet processing apparatus. In particular, the present invention relates to a technique of a purging process for, when a remaining sheet is remaining in the image forming system due to paper jam, appropriately ejecting the remaining sheet.

2. Description of Related Art

An image forming apparatus such as a printer and a copy machine which performs exposure by using a laser beam is required to deal with various image formation conditions. To meet this requirement, a plurality of sheet supply trays storing a plurality types of sheets are provided for each sheet. As the sheet supply tray, some image forming system have a sheet supply section, through which insert sheet is put in, provided in the downstream of an image forming section.

Further, in order to individually deal with a sheet on which various images are formed, an image forming system can be configured such that a sheet processing apparatus is connected with an image forming apparatus. In addition, in the case that various sheet processing apparatuses are connected to an image forming apparatus, a plurality of ejection sheet trays can be provided to be adapted to various sheet processing.

Note that if paper jam occurs in any position in the image forming system, the operation of the image forming system is suspended. Then, after the suspension of the operation, remaining sheets remaining in the image forming system are gathered and ejected to one ejection sheet tray. The technique in which remaining sheets in an image forming system are gathered and ejected to one ejection sheet tray is known as a purging process.

Note that about how to deal with residual sheets when paper jam occurs, related arts are described in Japanese Laid-Open Patent Application Publication No. Hei 10-250928 and Japanese Laid-Open Patent Application Publication No. Hei 11-292389.

In an image forming apparatus proposed in above Japanese Laid-Open Patent Application Publication No. Hei 10-250928, a plurality of vertically movable bin trays are provided in a sheet ejection section. Thus, a configuration is made such that a bin tray is moved to the sheet ejection section to which a sheet is actually ejected. It is proposed here that for the case that one of the bin trays is set as a tray for interruption, when jam occurs and the tray for interruption can be moved to a sheet ejection outlet before an unnecessary sheet is conveyed to the tray, the unnecessary sheet generated by the jam is ejected to the tray for interruption. However, there is disclosed no idea that a purge tray is set only for a purging process.

Alternatively, it is disclosed that in the image forming apparatus proposed in above Japanese Laid-Open Patent Application Publication No. Hei 11-292389, when paper jam occurs in any position in the image forming system, the purge tray is selected by a user, and the remaining sheets are gathered and ejected to the selected ejection sheet tray. However, there is disclosed no idea that a purge tray only for a purging process is automatically set.

Here, it is preferable that after sheet jam occurs, remaining sheets are gathered and automatically ejected as unnecessary sheets as a purging process, and the ejected unnecessary sheets are collectively discarded. However, in an actual image forming system, the unnecessary sheets in the purging process are ejected on a valid sheet on which an image has been normally formed. This causes a situation that the valid sheet and the unnecessary sheets are mixed. In addition, in the case that a plurality of users use an image forming system, there can be a situation that when a tray for the purging process is not determined, the valid sheet and the unnecessary sheet are mixed on the tray.

Note that such a purging process is also performed after the case of occurrence of blackout during image formation and an incorrect power-off operation during image formation, in the same manner for the case of the occurrence of paper jam. In addition, when the valid sheet and the unnecessary sheets are mixed as described above, a user needs to sort out the sheets into the valid sheet and the unnecessary sheet, confirming the sheet one by one. That is, conventionally there has been no method to appropriately eject remaining sheets.

### SUMMARY OF THE INVENTION

A sheet processing apparatus which reflects an aspect of the present invention and receives and processes a sheet on which an image is formed by an image forming apparatus, the sheet processing apparatus including:
an ejection section configured to eject the sheet to a plurality of different trays;
a controller configured to control such that the received sheet is ejected to any of the trays in the ejection section,
wherein the controller controls the ejection section such that when performing a purging process in which remaining sheets remaining in the sheet processing apparatus or the image forming apparatus are gathered and ejected to any of the trays in the ejection section, any of the trays other than a valid sheet tray which is a tray to which a sheet having a normally formed image has been ejected is set as a purge tray which is a tray to which the remaining sheets are to be ejected in the purging process, and then the remaining sheets are ejected to the purge tray.

It is preferably that the controller sets a tray which is on the most downstream side in a sheet conveyance direction and to which the remaining sheet can be ejected is set as the purge tray.

In this case, it is preferable that the controller selects the tray on the most downstream side in the sheet conveyance direction as a candidate for the purge tray and determines whether the remaining sheets can be ejected to the selected tray, and in the case that the remaining sheet can be ejected to the selected tray, the controller sets the selected tray as the purge tray.

However, in the case that the remaining sheets cannot be ejected to the selected tray, the controller select a tray positioned one tray upstream from the selected tray as a candidate for a purge tray, and when the remaining sheets can be ejected to such selected tray, the controller sets such selected tray as the purge tray.

It is preferable that a jam detection section configured to detect sheet jam is provided, wherein the controller detects a position at which sheet jam occurs frequently, based on a history of a detection result of the jam detection section, and the controller sets a tray in a vicinity of the detected position as the purge tray.

It is preferable that the controller sets as the purge tray a tray to which an unnecessary sheet is ejected, wherein the unnecessary sheet is a sheet not to be used as an output object.

It is preferable that each tray included in the ejection section is equipped with a sensor configured to detect placement of sheet, and when the controller refers to detection results of the sensors and the placement of sheet is detected from a state that a sheet has not been ejected, the controller sets the tray in which the placement of sheet has been detected as the purge tray.

It is preferable that each tray included in the ejection section is equipped with a sensor configured to detect placement of sheet, and when the controller refers to detection results of the sensors and the placement of sheet is detected from a state that a sheet has not been ejected, the controller sets the tray in which the placement of sheet has been detected as the valid sheet tray or the purge tray according to a setting or a selection.

It is preferable that after ejecting the remaining sheet to the purge tray by the purging process, the controller controls such that the purging process is performed with the purge tray being set as the ejection destination until the remaining sheets ejected in the purge tray are removed.

It is preferable that after ejecting the remaining sheet to the purge tray by the purging process, the controller controls such that the purging process is performed with the purge tray set as the ejection destination until the power of the image forming system is cut off.

It is preferable that the controller controls, when conveying sheets including an unnecessary sheet such as a chart, a blank sheet, and an unnecessary tab sheet which are not to be used for an output object, such that the unnecessary sheet is ejected to the tray to which the remaining sheets are ejected by the purging process.

### BRIEF DESCRIPTION OF THE DRAWINGS

One or more embodiments of the present invention are shown by way of example, and not limitation, in the accompanying figures, in which:

FIG. 1 is a block diagram illustrating a configuration of an image forming system of an embodiment of the present invention;

FIG. 2 is a configuration diagram illustrating an image forming system of an embodiment of the present invention;

FIG. 3 is a flow chart illustrating an operation of image formation of an embodiment of the present invention;

FIG. 4 is an explanatory diagram of an example of a screen during an operation of image formation of an embodiment of the present invention;

FIG. 5 is a flow chart showing an operation of image formation of an embodiment of the present invention;

FIG. 6 is a flow chart illustrating an operation of image formation of an embodiment of the present invention;

FIG. 7 is a flow chart illustrating an operation of image formation of an embodiment of the present invention;

FIG. 8 is a flow chart illustrating an operation of image formation of an embodiment of the present invention; and

FIG. 9 is a flow chart illustrating an operation of image formation of an embodiment of the present invention.

### DETAILED DESCRIPTION OF THE INVENTION

With reference to the drawings, a configuration (hereinafter, referred to as an embodiment) for practicing the present invention will be described in detail below.

[Overall Configuration]

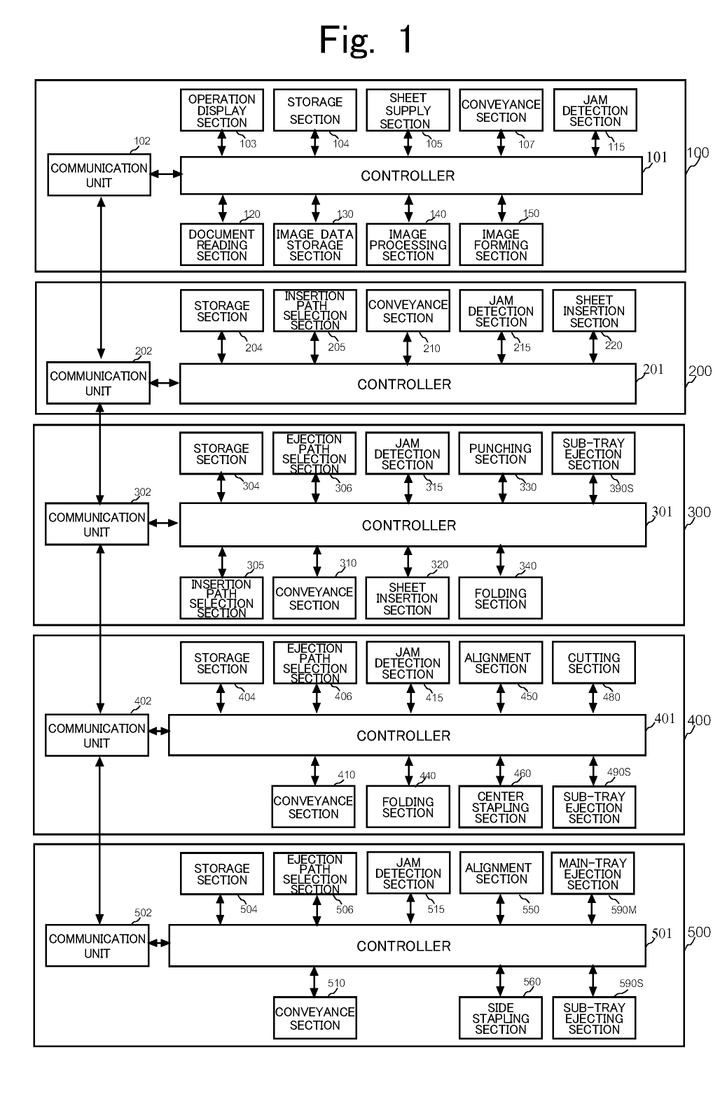

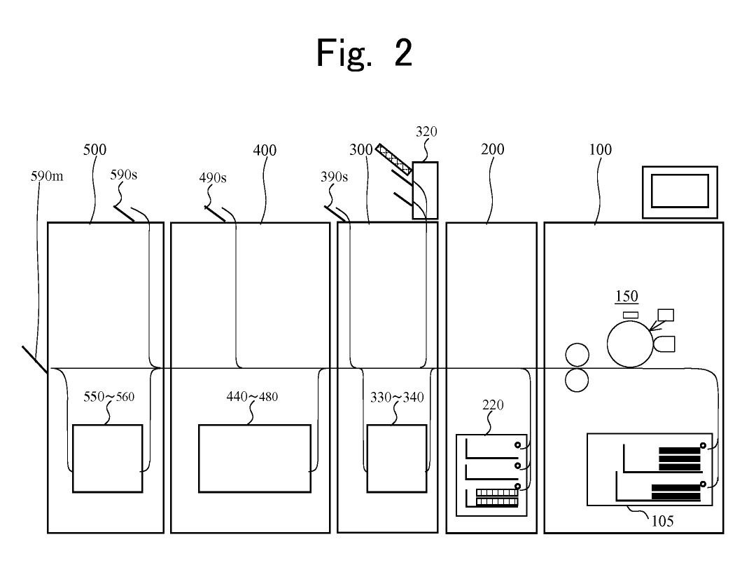

With reference to FIG. 1 to FIG. 2, there will be described a configuration of an image forming system equipped with an image forming apparatus and a sheet processing apparatus according to the embodiment.

As illustrated in FIG. 1 to FIG. 2, the image forming system is configured with an image forming apparatus 100, an insert-sheet inserting device 200, a sheet processing apparatus 300, a sheet processing apparatus 400, and a sheet processing apparatus 500, which are connected.

Here, the insert-sheet inserting device 200 has a function as a PI-PFU (Paper Insert-Paper Feed Unit) which inserts an insert sheet in a subsequent stage of the image forming apparatus 100. The sheet processing apparatus 300 is equipped with an insert-sheet inserting function and a sheet processing function. The sheet processing apparatus 300 is equipped with a sheet processing function. The sheet processing apparatus 400 is equipped with a sheet processing function. The sheet processing apparatus 500 is equipped with a sheet processing function. Note that the connection state of the devices of the image forming system is an example, and is not limited by the connection state illustrated in the drawings.

The image forming apparatus 100 is configured to have a controller 101, a communication unit 102, an operation/display section 103, a storage section 104, a sheet supply section 105, a conveyance section 107, a jam detection section 115, a document reading section 120, an image data storage section 130, an image processing section 140, and an image forming section 150. Note that the sheet on which an image is formed in the image forming apparatus 100 is conveyed to the insert-sheet inserting device 200 in the subsequent stage.

Here, the controller 101 controls the sections in the image forming apparatus 100 and the whole of the system. The communication unit 102 has a function to communicate with other devices connected thereto. The operation/display section 103 informs the operator to the controller 101 of operation input signals according to the operation input of an operator and displays a state of the image forming apparatus 100. The storage section 104 stores a control program and various setting data and is used as a working area of the control program. The sheet supply section 105 supplies sheets stored in a tray to the image forming section 150. The conveyance section 107 conveys a sheet which is supplied and on which an image is to be formed, at a predetermined speed. The jam detection section 115 detects sheet jam (jam) by using sensors provided at various positions in the image forming apparatus 100. The document reading section 120 scans a document to generate image data The image data storage section 130 stores image data for forming an image and various data. The image processing section 140 performs various kinds of image processing required to form an image. The image forming section 150 performs printing (hereinafter, referred to as “image formation”) based on an image formation instruction and image data having been image-processed.

The insert-sheet inserting device 200 is connected to the stage subsequent to the image forming apparatus 100 and is configured to have a controller 201, a communication unit 202, a storage section 204, an insertion path selection section 205, a conveyance section 210, a jam detection section 215, and a sheet insertion section 220. Note that a sheet having been conveyed through the insert-sheet inserting device 200 is conveyed toward the sheet processing apparatus 300 in the subsequent stage.

Here, the controller 201 controls the sections in the insert-sheet inserting device 200. The communication unit 202 has a function to communicate with the image forming apparatus 100. The storage section 204 stores a control program and various setting data and is used as a working area of the control program. The insertion path selection section 205 selects an insertion path in which an insert sheet is inserted. The conveyance section 210 conveys a sheet at a predetermined speed. The jam detection section 215 detects sheet jam (jam) by using sensors provided at various positions in the insert-sheet inserting device 200. The sheet insertion section 220 inserts a stored insert sheet in the sheet conveyance path.

The sheet processing apparatus 300 is connected to the subsequent stage of the image forming apparatus 100 and the insert-sheet inserting device 200 and is configured to have a controller 301, a communication unit 302, a storage section 304, an insertion path selection section 305, an ejection path selection section 306, a conveyance section 310, a jam detection section 315, a sheet insertion section 320, a punching section 330, a folding section 340, and a sub-tray ejection section 390S. Note that the sheet having been conveyed through the sheet processing apparatus 300 is conveyed toward the sheet processing apparatus 400 in the subsequent stage.

Here, the controller 301 controls sections in the sheet processing apparatus 300. The communication unit 302 has a function to communicate with the image forming apparatus 100. The storage section 304 stores a control program and various setting data and is used as a working area of the control program. The insertion path selection section 305 selects an insertion path in which an insert sheet is inserted. The ejection path selection section 306 selects an ejection path through which a post-processed sheet bundle is ejected. The conveyance section 310 conveys a sheet at a predetermined speed. The jam detection section 315 detects sheet jam (jam) by using sensors provided at various positions in the sheet processing apparatus 300. The sheet insertion section 320 has a function to insert an insert sheet stored in a PI (Paper Inserter) section in the sheet conveyance path. The punching section 330 has a function to punch file holes. The folding section 340 have a function to fold a sheet at centerfold or threefold. The sub-tray ejection section 390S has a function to eject a sheet to a sub tray as an ejection destination.

The sheet processing apparatus 400 is connected to the subsequent stage of the sheet processing apparatus 300 and is configured to have a controller 401, a communication unit 402, a storage section 404, an ejection path selection section 406, a conveyance section 410, a jam detection section 415, a folding section 440, an alignment section 450, a center stapling section 460, a cutting section 480, and a sub-tray ejection section 490S. Note that the sheet having been conveyed through the sheet processing apparatus 400 is conveyed toward the sheet processing apparatus 500 in the subsequent stage.

Here, the controller 401 controls sections in the sheet processing apparatus 400. The communication unit 402 has a function to communicate with the image forming apparatus 100, the sheet processing apparatus 300, and the like. The storage section 404 stores a control program and various setting data and is used as a working area of the control program. The ejection path selection section 406 selects an ejection path through which a post-processed sheet bundle is ejected. The conveyance section 410 conveys a sheet at a predetermined speed. The jam detection section 415 detects sheet jam (jam) by using sensors provided at various positions in the sheet processing apparatus 400. The folding section 440 has a function to fold a sheet at centerfold or threefold. The alignment section 450 has a function to align a plurality of folded sheets. The center stapling section 460 has a function to staple a folded and aligned sheet bundle. The cutting section 480 has a function to cut off the fore edge of the center-folded sheet bundle. The sub-tray ejection section 490S ejects a sheet to a sub tray as an ejection destination.

The sheet processing apparatus 500 is connected to the subsequent stage of the sheet processing apparatus 400 and is configured to have a controller 501, a communication unit 502, a storage section 504, an ejection path selection section 506, a conveyance section 510, a detection section 515, an alignment section 550, a side stapling section 560, a sub-tray ejection section 590S, and a main-tray ejection section 590M.

Here, the controller 501 controls the sections in the sheet processing apparatus 500. The communication unit 502 has a function to communicate with the image forming apparatus 100, the sheet processing apparatus 400, and the like. The storage section 504 stores a control program and various setting data and is used as a working area of the control program. The ejection path selection section 506 selects an ejection path through which the post-processed sheet bundle is ejected. The conveyance section 510 conveys a sheet at a predetermined speed. The jam detection section 515 detects sheet jam (jam) by using sensors provided at various positions in the sheet processing apparatus 500. The alignment section 550 has a function to align a plurality of sheets. The side stapling section 560 has a function to staple an aligned sheet bundle. The sub-tray ejection section 590S has a function to eject a sheet to a sub tray as an ejection destination. The main-tray ejection section 590M has a function to eject a sheet and a booklet to a main tray as an ejection destination.

Note that the sheet processing functions and the sections in the above sheet processing apparatuses 300-500 are examples and are not limited thereto.

### [Operation of the Embodiment]

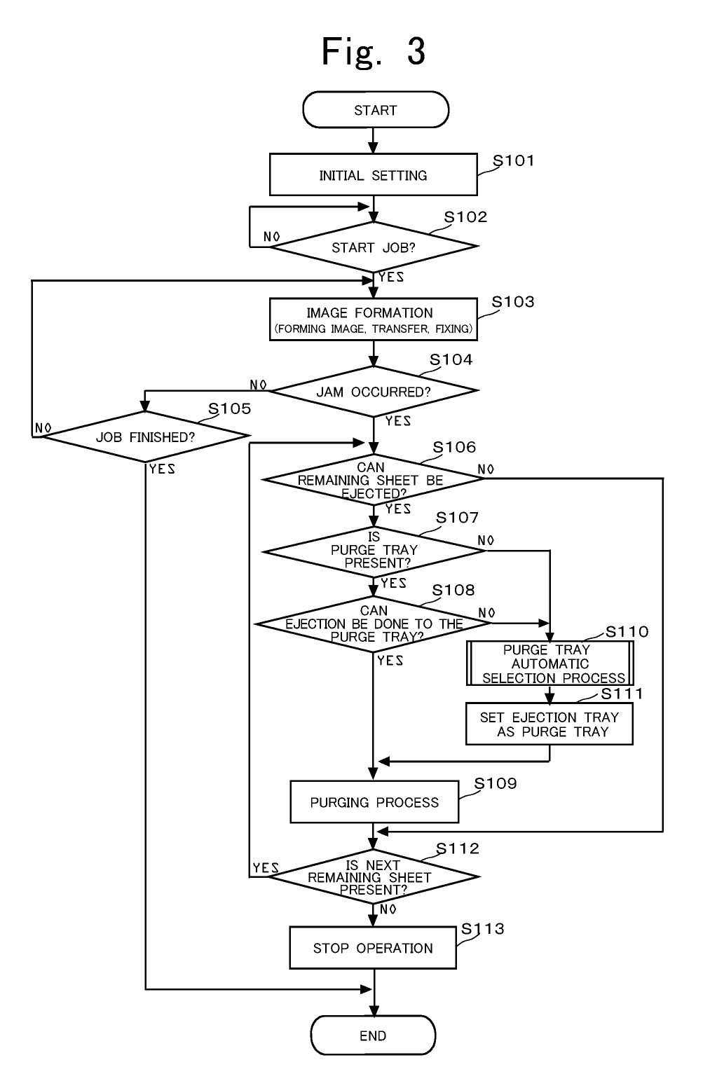

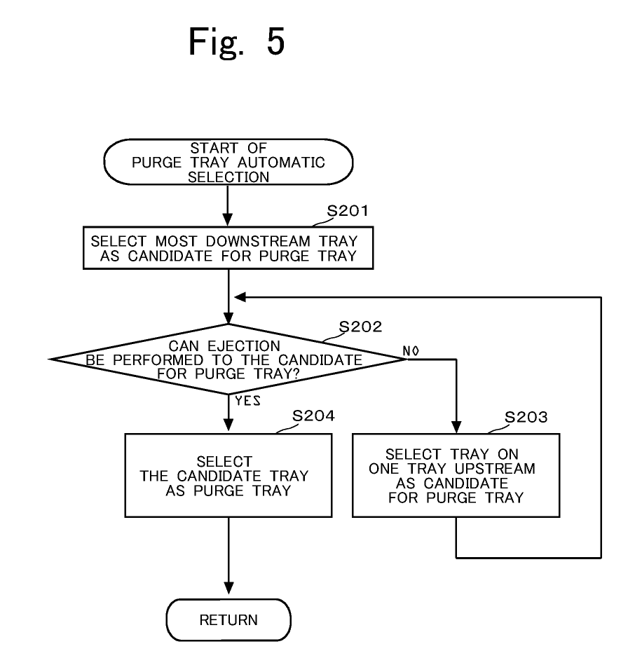

Below, the sheet processing apparatus, the image forming system, and the sheet processing control method of the embodiment will be described, following the procedure of the operation, with reference to a flow chart (FIG. 3) of a main routine and flow charts (FIG. 5-FIG. 9) of a subroutine.

Note that in the embodiment the purging process has two meanings: to gather and eject, after the occurrence of jam, the remaining sheets which can be ejected to one ejection sheet tray; and to gather and eject, after the jammed sheet is removed after the occurrence of jam, the remaining sheets which can be ejected to one ejection sheet tray. In the following description of the embodiment, the purging process has the both meanings.

### General Control (Main Routine)

FIG. 3 is a flow chart illustrating a main routine, which is a basic operation in the image forming system of the embodiment.

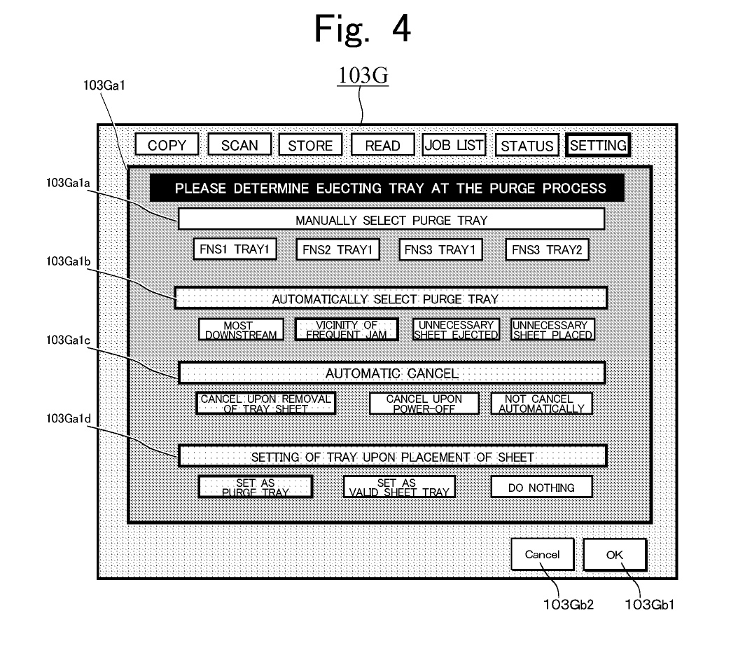

First, the controller 101 performs initial setting (step S101 in FIG. 3) related to the purging process. For example, the controller 101 displays an operation/display screen 103G (shown in FIG. 4) on the operation/display section 103 and receives operations of setting by a user. Here, the user inputs, in the operation/display section 103, options as the initial setting, which options represent whether, when the purging process is performed, the purge tray is manually selected or automatically selected and what is, when the purge tray is automatically selected, preferentially selected.

Here, in a setting screen 103Ga1 in the operation/display screen 103G (shown in FIG. 4), there are options such as “Manually select Purge Tray” (reference numeral 103Ga1a in FIG. 4), and “Automatically Select Purge Tray” (reference numeral 103Ga1b in FIG. 4). In addition, there are options such as, for the case of the automatic selection of the purge tray, “Prioritize Most Downstream Tray”, “Prioritize Tray in Vicinity of Frequent Jam Occurrence Position”, and “Prioritize Unnecessary Sheet Ejection Tray.” Further, there are options such as, for the case of cancelling the automatic selection of the purge tray, “Cancel upon Removal of Tray Sheet”, “Cancel upon Power-off”, and “Not Cancel Automatically.”

In addition, there are options such as, when sheets are not ejected from the apparatus but placed in the tray, the tray is assigned to the purge tray (purge tray automatic selection), the tray is assigned to the valid sheet tray, nothing is done.

In the screen example in FIG. 4, in the item “Automatic Selection”, there is displayed a state that “Vicinity of Frequent Jam Occurrence Position” is selected. In the item “Automatic Cancellation,” there is displayed a state that “Cancel upon Removal of Sheet” is selected. In the item “Tray Setting upon Placement of Sheet,” there is displayed a state that “Set as Purge Tray” is selected.

When the user completed the setting on the setting screen 103Ga1 in the operation/display screen 103G, and the user press an OK button 103Gb1, the controller 101 stores the initial settings of the purging process in the storage section 104 and the like.

Then, an instruction to start the job related to image formation is input (step S102 in FIG. 3: YES) by pressing the start button of the operation/display section 103, the instruction from an external PC, or the like. Upon the input, the controller 101 controls such that job-starting information for declaring the star of job is sent to the insert-sheet inserting device 200 and the sheet processing apparatuses 300-500 in the subsequent stages. In addition, the controller 101 controls such that image formation (forming image, transfer, and fixing) is performed by the image forming section 150 (step S103 in FIG. 3).

Here, the controller 101 determines, by referring to job information about the job to be performed, a sheet from which sheet supply tray are supplied or inserted in order of the image formation. When a sheet is supplied from the sheet supply section 105 in the image forming apparatus 100, the controller 101 instructs the sheet supply section 105 to supply a sheet. When a sheet is inserted from the sheet insertion section 220 of the insert-sheet inserting device 200, the controller 101 instructs, by way of the controller 201, the sheet insertion section 220 to insert the sheet. When a sheet is inserted from the sheet insertion section 320 of the sheet processing apparatus 300, the controller 101 instructs, by way of the controller 301, the sheet insertion section 320 to insert the sheet.

Note that, when the occurrence of sheet jam (jam) is not detected (step S104 in FIG. 3: NO), the controller 101 controls the sections to repeat sheet supply, image formation, and insertion of a required sheet with respect to all the sheets on which images are to be formed as the job (FIG. 3, step S105: NO then S103; S105: YES then END).

At this time, an occurrence of sheet jam (jam) is detected by any of the jam detection sections 115-515 (FIG. 3, step S104: YES). At this time of occurrence of jam, the controller 101 suspends the operation of the image forming system, and determines whether a remaining sheet remaining in the image forming system can be ejected. The controller 101 confirms whether there is a remaining sheet by referring to the sheet information at the time of execution of image formation, results of passing check from the sensors at the various positions, and the like. In addition, the controller 101 determines whether the remaining sheet can be ejected, by referring to the sheet information at the time of execution of image formation, the result of passing check of from the sensors at various positions, and the like.

At this time, since the remaining sheets are conveyed to the downstream side to be ejected, the controller 101 determines possibility of ejection for each remaining sheet in order from the most downstream side. If it is determined to be impossible to eject the remaining sheet (FIG. 3, step S106: NO), the controller 101 repeatedly determines from downstream toward upstream whether there is a remaining sheet (FIG. 3, step S112), and determines, if there is (FIG. 3, step S112: YES) possibility of ejection (FIG. 3, step S106).

If it is possible to eject the remaining sheet (FIG. 3, step S106: YES), the controller 101 determines whether any ejection sheet tray is set as the purge tray (FIG. 3, step S107). Here, the purge tray is an ejection destination to which remaining sheets are gathered and ejected after the occurrence of jam or after the removal of jammed sheet, and is a tray in which any valid sheet processed by a normal image formation is not placed and which is a tray having set as a purge tray. That is to say, that the expression “there is a purge tray” means that there is a tray having set as a purge tray.

If there is a purge tray (FIG. 3, step S107: YES), the controller 101 determines whether it is possible to eject the remaining sheet to that purge tray (FIG. 3, step S108).

If there is a purge tray (FIG. 3, step S107: YES) and it is possible to eject the remaining sheet to that purge tray (FIG. 3, step S108: YES), the controller 101 controls the sections to perform the purging process by ejecting the remaining sheet to that purge tray (FIG. 3, step S109). That is to say, the controller 101 instructs the sheet processing apparatuses 300-500 having a tray set as a purge tray to eject the remaining sheets, and some of the sheet processing apparatuses 300-500 having received the instruction eject the remaining sheets.

On the other hand, there is no purge tray (FIG. 3, step S107: NO), or it is impossible to eject the remaining sheet to the existing purge tray (FIG. 3, step S107: YES and S108: NO), the controller 101 controls as follows. The controller 101 performs a purge tray automatic selection process (FIG. 3, step S110) which will be described in detail with respect to FIG. 5 and later. That is to say, the controller 101 sets the tray selected by the automatic selection process as the purge tray (FIG. 3, step S111). Then, the controller 101 controls the sections to perform the purging process by ejecting the remaining sheet to the tray set as the purge tray (FIG. 3, step S109).

After repeating the above process with respect to the all remaining sheets remaining in the image forming system (FIG. 3, step S112: NO), the controller 101 suspends the operation of the image forming system to stop operation (FIG. 3, step S113, END).

Purge Tray Automatic Selection Process (1)

FIG. 5 is a flow chart illustrating a first example of a subroutine as a detailed content of a purge tray automatic selection process of the embodiment.

Here, as the purge tray automatic selection process, the position of the tray in the image forming system is used as a parameter for performing automatic selection. First, the controller 101 selects a tray disposed in the most downstream side as a candidate for a purge tray (FIG. 5, step S201). In the example shown in FIG. 1 and FIG. 2, a sub tray 590s and a main tray 590m provided in the sheet processing apparatus 500 correspond to the candidates. Here, considering that the main tray 590m is assigned to a normal image formation, the controller 101 select the sub tray 590s as the candidate for the purge tray.

Then, the controller 101 determines whether it is possible to eject the remaining sheet by the purging process to the tray selected as the candidate for the purge tray (FIG. 5, step S202). Note that the expression “to be possible to eject the remaining sheet” means that the tray set as the candidate for the purge tray is not yet assigned to other purposes such as an output destination for valid sheets processed by a normal image formation or blank sheets for reuse.

If it is impossible to eject the remaining sheet by the purging process to the tray selected as the candidate for the purge tray (FIG. 5, step S202: NO), the controller 101 selects the tray located on the upstream side by one tray as the candidate for the purge tray (FIG. 5, step S203). Note that in the example illustrated in FIG. 1 and FIG. 2, the tray on the one tray upstream of the sub tray 590s corresponds to the sub tray 490s disposed on the sheet processing apparatus 400.

In the above-described manner, the controller 101 selects, as the candidate for the purge tray, the tray which is located on the most downstream within a range in which the remaining sheet can be ejected (FIG. 5, steps S202, S203, and S204).

Then the candidate for the purge tray automatically selected in this way (FIG. 3, step S110 (FIG. 5, steps S201-S204)) is set as the purge tray by the controller 101 (FIG. 3, step S111)

By setting as the purge tray the tray which is on the most downstream side within the range in which the remaining sheet can be ejected, it is easy to gather, in one place, the remaining sheets which are conveyed to the downstream side by the purging process and to eject them without being mixed with other sheets as far as possible.

Purge Tray Automatic Selection Process (2)

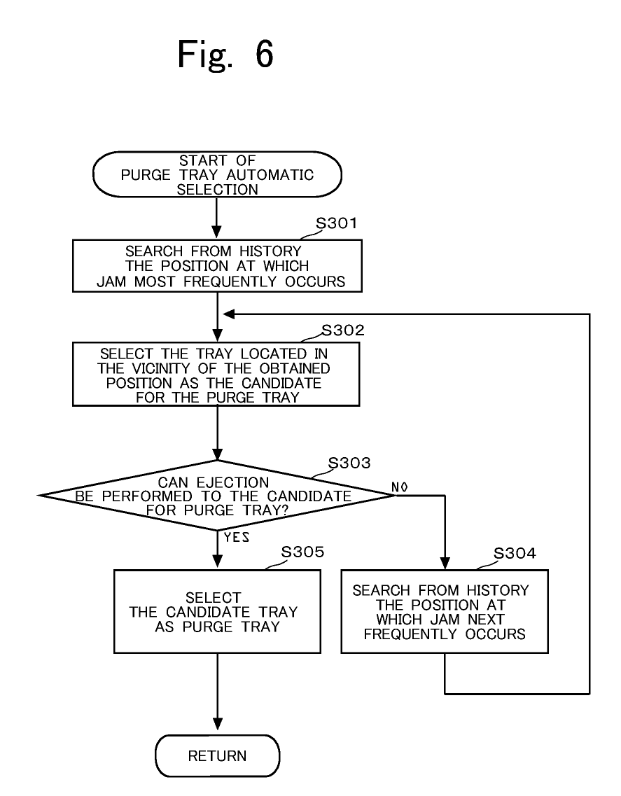

FIG. 6 is a flow chart illustrating a second example of a subroutine as a detailed content of a purge tray automatic selection process of the embodiment.

Here, as the purge tray automatic selection process, a position in the image forming system at which jam frequently occurs is used as a parameter for performing automatic selection. The controller 101 controls in the image forming system such that a jam detection result including information about an occurrence of jam is stored in the storage section 104 every time the jam occurs. After that, the controller 101 recalls from the storage section 104 a history in which the results of jam detection in the image forming system are accumulated, and obtains the position at which jams occur most frequently (FIG. 6, step S301).

Then, the controller 101 selects the tray located in the vicinity of the obtained position as the candidate for the purge tray (FIG. 6, step S302). Note that the vicinity is not defined by an absolute value of distance but indicates one or two trays, of the plurality of trays, close to the position at which jams occurs most frequently.

In the example illustrated in FIG. 1 and FIG. 2, if it is assumed that jam occurs most frequently at the section connecting the sheet processing apparatus 400 and the sheet processing apparatus 500, the sub tray 490s on the upstream side in the sheet conveyance direction and the sub tray 590s in the downstream side in the sheet conveyance direction are selected as the candidates for the purge tray.

Then, the controller 101 determines whether the remaining sheet can be ejected by the purging process to the tray selected as the candidate for the purge tray (FIG. 6, step S303). Note that the expression “to be possible to eject the remaining sheet” means that the tray set as the candidate for the purge tray is not yet assigned to other purposes.

Here, it is impossible to eject the remaining sheet by the purging process to the tray selected as the candidate for the purge tray (FIG. 6, step S303: NO), the controller 101 select another candidate for the purge tray as described below. The controller 101 obtains the position at which jam occurs second most frequently by referring to the history in which the results of jam detection in the image forming system are accumulated (FIG. 6, step S304). Then, the controller 101 selects the tray located in the vicinity of the obtained position as the candidate for the purge tray (FIG. 6, step S302). Then, the controller 101 determines whether it is possible to eject the remaining sheet by the purging process to the tray selected as the candidate for the purge tray (FIG. 6, step S303).

As described above, the controller 101 selects, as the candidate for the purge tray (FIG. 6, step S305), the tray in the vicinity of the position at which the frequency of occurrence of jam is high, in a range in which the remaining sheet can be ejected (FIG. 3, step S303: YES). Then, the candidate for the purge tray automatically selected in this way (FIG. 3, S110 (FIG. 6, steps S301-S305)) is set as the purge tray by the controller 101 (FIG. 3, step S111).

In the case that the tray on the upstream side of a jam frequently occurring position is set as the purge tray, that tray is used for the purging process for ejecting the remaining sheet which can be ejected, after the jam has occurred. On the other hand, in the case that the tray on the downstream side of the jam frequently occurring position is set as the purge tray, that tray is used for the purging process for ejecting the remaining sheet which can be rejected, after the jammed sheet has been removed after the occurrence of jam.

By setting as the purge tray the tray located in the vicinity of the position at which jam occurs most frequently and which is in the range in which the remaining sheet can be rejected, the following two operations can be easy being performed in close places: an operation for removing the jammed sheet from inside of the apparatus as a jam recovery process; and an operation for removing from the purge tray the remaining sheet ejected by the purging process. Thus, the remaining sheet ejected by the purging process can be in such a state that the sheet can be removed easily and surely without being mixes with other sheets.

Purge Tray Automatic Selection Process (3)

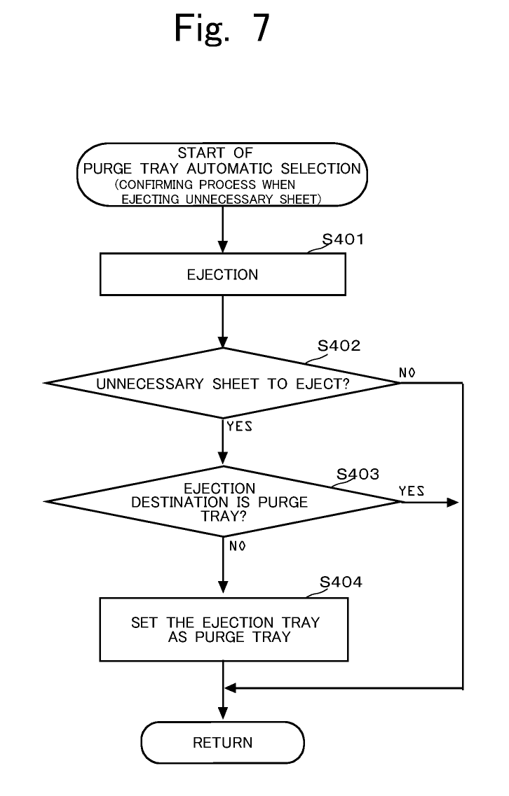

FIG. 7 is a flow chart illustrating a third example of a subroutine as a detailed content of a purge tray automatic selection process of the embodiment.

Here, as the purge tray automatic selection process, the tray to which an unnecessary sheet generated in the image formation, the image adjustment, and the like is ejected is assigned to an object of the purge tray automatic selection. Note that the unnecessary sheet is a sheet which is not used for an output object and is, for example, an unnecessary tab sheet, an unnecessary blank sheet, an unnecessary partition sheet, a chart sheet for image adjustment, and the like. Further, the unnecessary sheet corresponds to various types of sheets other than the sheets which are used as output objects by a normal image formation.

Note that FIG. 7 is the purge tray automatic selection process and is also a subroutine to be executed to confirm the sheet to be ejected in all the ejection sections.

First, the controller 101 confirms, when ejecting various sheets in any of the ejection sections (FIG. 7, step S401) in various processes such as the image formation and the image adjustment, whether the sheet to be ejected is an unnecessary sheet (FIG. 7, step S402).

Here, if the sheet to be ejected is not an unnecessary sheet (FIG. 7, step S402: NO), the controller 101 terminates this process (FIG. 7, RETURN). On the other hand, the sheet to be ejected is an unnecessary sheet (FIG. 7, step S402: YES), the controller 101 confirms whether the ejection destination is the tray already set as the purge tray (FIG. 7, step S403).

Here, if the ejection destination of an unnecessary sheet is the purge tray (FIG. 7, step S403: YES), the controller 101 terminates this process (FIG. 7, RETURN). On the other hand, the sheet to be ejected is an unnecessary sheet (FIG. 7, step S402: YES) and the ejection destination of the unnecessary sheet is not the purge tray (FIG. 7, step S403: NO), the controller 101 sets this ejection destination as the purge tray (FIG. 7, step S404), then terminates this process (FIG. 7, RETURN).

By setting as the purge tray the tray to which the unnecessary sheet not to be used as an output object is ejected, the remaining sheet to be ejected by the purging process is ejected to the same tray as an unnecessary sheet is ejected, as a result the remaining sheet related to the purging process is surely ejected without being mixed with valid sheets.

In addition, by controlling such that conveying sheets including an unnecessary sheet not to be used as an output object and ejecting the unnecessary sheet to the purge tray when ejecting the unnecessary sheet (FIG. 7, step S402: YES, S403: YES), the unnecessary sheet and valid sheets are not mixed with respect to the unnecessary sheet other than the purging process. That is to say, the unnecessary sheet other than the purging process can be ejected appropriately, and the purge tray can be used effectively.

Purge Tray Automatic Selection Process (4)

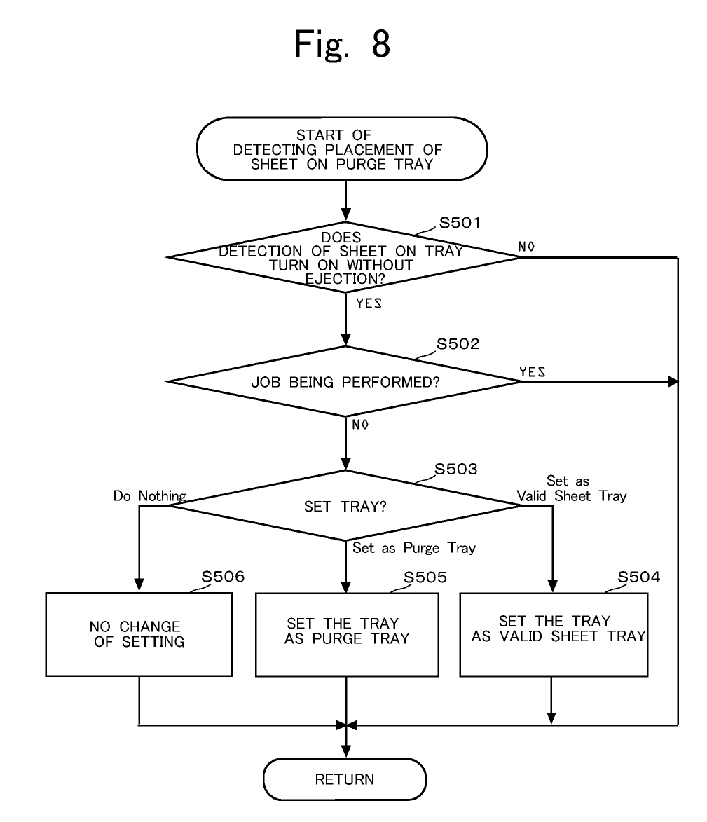

FIG. 8 is a flow chart illustrating a fourth example of a subroutine as a detailed content of a purge tray automatic selection process of the embodiment.

Here, each tray in each of the ejection sections is equipped with a sensor for detecting placement of sheet. As the purge tray automatic selection process, the controller 101 refers to the detection results of the sensors, and in the case that the placement of sheet is detected from the state that no sheet is ejected from the apparatus, the controller 101 sets the tray in which the placement of sheet is detected as the purge tray.

Note that FIG. 8 is a purge tray automatic selection process and is also a subroutine to be executed to detect the placement of sheet in all the trays of the ejection sections. First, the controller 101 is watching whether a sheet is placed, by referring to the detection result of the sensor in each tray in the ejection sections (FIG. 8, step S501). In addition, the controller 101 determines whether the placement of sheet in the tray is occurred during a job (FIG. 8, step S502).

If no sheet is placed in the tray, in other words, no change occurs to the sensor of each tray (FIG. 8, step S501: NO), this process is terminated (FIG. 8, RETURN). Alternatively, any of the sensors on the trays changes from “off” to “on” (FIG. 8, step S501: YES), and the change to “on” is not occurred during a job (FIG. 8, step S502: NO), the controller 101 determines that the placement is not due to the ejection from the apparatus but is due to the placement in the tray from outside the apparatus. Here, in the initial setting shown in FIG. 4, the controller 101 refers to which of “Set as Purge Tray”, “Set as Valid Sheet Tray”, and “Do Nothing” has been set in the item of “Setting of Tray upon Placement of Sheet” (FIG. 4, 103Ga1d). In particular, the controller 101 determines, according to the initial setting (FIG. 8, step S503), to set the tray as the valid sheet tray (FIG. 8, step S504), the tray as the purge tray (FIG. 8, step S505), or not to set the tray (FIG. 8, step S506).

In this case, not only in the initial setting but when a determination becomes necessary (FIG. 8, step S503), the controller 101 may ask, via the operation/display section 103, a user for instructions and selection.

Note that “the case that placement of sheet on any of the trays is detected from the state that no sheet is ejected from the apparatus” is “the case that some sort of sheet is placed on a tray by a user.” When a sheet is placed by a user in this way, the placed sheet is not a valid sheet in many cases. For this reason, it is preferable to select “Set as Purge Tray” with respect to the tray on which the sheet is placed, in the item of “Setting of Tray upon Placement of Sheet” (FIG. 4, 103Ga1d) in the initial setting of FIG. 4. According to this setting, when a sheet is placed on a tray, the tray is set as the purge tray in the flow chart of FIG. 8 (FIG. 8, step S505).

As described above, by setting, if placement of sheet on any of the trays is detected from the state that no sheet is ejected from the apparatus (FIG. 8, step S501: YES, S502: NO), the tray in which the placement of sheet is detected as the purge tray (FIG. 8, step S505) according to the initial setting (FIG. 8, step S503: PURGE TRAY), the remaining sheet can be appropriately ejected without the valid sheet and the unnecessary sheet being mixed.

Purge Tray Automatic Selection Process (5)

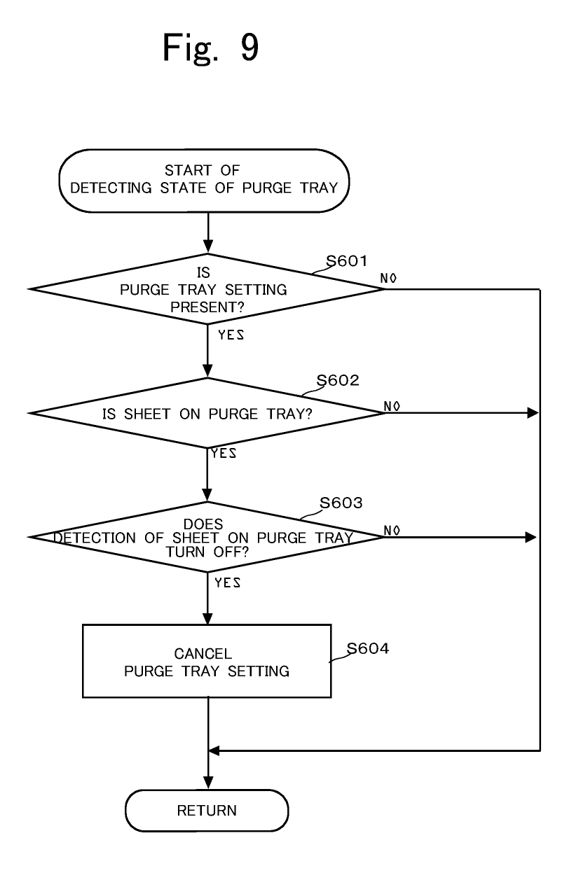

FIG. 9 is a flow chart illustrating a fifth example of a subroutine as a detailed content of a purge tray automatic selection process of the embodiment

Here, each tray in each of the ejection sections is equipped with a sensor for detecting placement of sheet. As the purge tray automatic selection process, the controller 101 automatically cancels the setting of the purge tray, based on the existence/non-existence or the change in the placing state of the selected purge tray.

First, the controller 101 recalls the setting of the purge tray from the storage section 104 or the register in the controller 101 (FIG. 9, step S601). If the setting as the purge tray is not set (FIG. 9, step S601: NO), the controller 101 terminates this process.

Alternatively, the setting as the purge tray is set (FIG. 9, step S601: YES), the controller 101 confirms whether a sheet is in the purge tray, by referring to the detection result of the sensor which detects placement of sheet (FIG. 9, step S602).

If no sheet (FIG. 9, step S602: NO) is in the tray set as the purge tray (FIG. 9, step S601: YES), the controller 101 terminates this process. In the case that a sheet is placed (FIG. 9, step S602: YES) in the tray set as the purge tray (FIG. 9, step S601: YES), if the detection result of the sensor for detecting placement of sheet in the purge tray does not change (FIG. 9, step S603: NO), the controller 101 terminate this process.

In the case that a sheet is placed (FIG. 9, step S602: YES) in the tray set as the purge tray (FIG. 9, step S601: YES), if the sensor for detecting for placement of sheet in the purge tray has changed from “on” to “off” (FIG. 9, step S603: YES), it means that the sheet placed in the purge tray has been removed. Here, the controller 101 refers to which of the “Cancel upon Removal of Sheet”, “Cancel upon Power-off”, and “Not Cancel” is set in the item “Automatic Cancel” (FIG. 4, 103Ga1c) in the initial setting of FIG. 4. If “Cancel upon Removal of Sheet” has been selected as the initial setting of the automatic cancel as shown in FIG. 4, the controller 101 cancels the setting of the purge tray with respect to the tray (FIG. 9, step S604).

When the setting of the purge tray has been cancelled in this manner, an appropriate purge tray will be newly selected by the above-described automatic selection. In addition, the cancelled tray can be used for purposes other than the purge tray. Further, in the case that a plurality of purge trays are set, useless setting for the tray from which a remaining sheet has been removed can be cancelled. Therefore, it is possible to use the tray effectively.

Here, the setting of the purge tray is made to be cancelled upon the removal of sheets; however, a setting can be done in which the setting of the purge tray is maintained, based on the initial setting, as long as the image forming system is in the state of power-on. In this case, when the purging process is performed in the period since the image forming system is turned on until the system is turned off; and it is possible to appropriately eject a remaining sheet without being mixes with a valid sheet and an unnecessary sheet.

### Other Embodiment (1)

The embodiment of the present invention has been described with reference to the drawings; however, specific configurations or numbers are not limited to those shown in the embodiment, and modifications and changes are included in the present invention unless they depart from the spirit of the present invention.

In the above-description of the embodiment, the controller 101 in the image forming apparatus 100 surely controls when performing the purging process; however, the embodiment does not limit the invention.

In order to perform the same purging process as described above, the controllers 201-501 in the devices 200-500 other than the image forming apparatus 100 may instruct other controllers to perform the control of the above purging process.

In this case, when devices other than the image forming apparatus 100 which controls the purging process has an operation/display section, that operation/display section may be used. Alternatively, when an operation/display section is not equipped, it may be possible that information is sent to the image forming apparatus 100 and to use the operation/display section 103 in the image forming apparatus 100 to receive settings and display results.

In other words, the controllers 301-501, on behalf of the controller 101, in the sheet processing apparatuses 300-500 having a tray which can be set as the purge tray can perform the purge tray automatic selection process.

In this case, any of the controllers 301-501 can obtain necessary information from the controller 101 and take the lead completely instead of the controller 101. In this case, a plurality of controllers in the controllers 301-501 may obtain necessary information from the controller 101 and collectively take the lead completely instead of the controller 101.

Alternatively, the controllers 301-501 can perform the purge tray automatic selection process and then inform the controller 101 of a selection result of the purge tray so that the controller 101 can generally control.

### Other Embodiment (2)

In the above embodiment, it is assumed that the remaining sheet is created by sheet jam (jam); however, the embodiment does not limit the invention. For example, also when the conveyance of a sheet stops when forming an image due to a trouble (for example, trouble with a motor or a gear for driving a conveyance roller) in any part in the image forming system or a blackout, and a remaining sheet is created, the above embodiments can be applied.

What is claimed is:

1. A sheet processing apparatus which receives and processes a sheet on which an image is formed by an image forming apparatus, the sheet processing apparatus comprising:
an ejection section configured to eject the sheet to a plurality of different trays;
a controller configured to control such that the received sheet is ejected to any of the trays in the ejection section,
wherein the controller controls the ejection section such that when performing a purging process in which remaining sheets remaining in the sheet processing apparatus or the image forming apparatus are gathered and ejected to any of the trays in the ejection section, any of the trays other than a valid sheet tray which is a tray to which a sheet having a normally formed image has been ejected is set as a purge tray which is a tray to which the remaining sheets are to be ejected in the purging process, and then the remaining sheets are ejected to the purge tray.

2. The sheet processing apparatus of claim 1, wherein the controller sets a tray which is on the most downstream side in a sheet conveyance direction and to which the remaining sheet can be ejected is set as the purge tray.

3. The sheet processing apparatus of claim 1, comprising:
a jam detection section configured to detect sheet jam,
wherein the controller detects a position at which sheet jam occurs frequently, based on a history in which detection results of the jam detection section are accumulated, and the controller sets a tray in a vicinity of the detected position as the purge tray.

4. The sheet processing apparatus of claim 1, wherein the controller sets as the purge tray a tray to which an unnecessary sheet is ejected, wherein the unnecessary sheet is a sheet not to be used as an output object.

5. The sheet processing apparatus of claim 1, wherein each tray included in the ejection section is equipped with a sensor configured to detect placement of sheet, and when the controller refers to detection results of the sensors and the placement of sheet is detected from a state that a sheet has not been ejected, the controller sets the tray in which the placement of sheet has been detected as the purge tray.

6. The sheet processing apparatus of claim 1, wherein each tray included in the ejection section is equipped with a sensor configured to detect placement of sheet, and when the controller refers to detection results of the sensors and placement of sheet is detected from a state that a sheet has not been ejected, the controller sets the tray in which the placement of sheet has been detected as the valid sheet tray or the purge tray according to a setting or a selection.

7. The sheet processing apparatus of claim 1, wherein ager ejecting the remaining sheet to the purge tray by the purging process, the controller controls such that the purging process is performed with the purge tray being set as the ejection destination until the remaining sheets ejected in the purge tray are removed.

8. The sheet processing apparatus of claim 1, wherein after ejecting the remaining sheet to the purge tray by the purging process, the controller controls such that the purging process is performed with the purge tray set as the ejection destination until the power of the image forming apparatus is cut off.

9. The sheet processing apparatus of claim 1, wherein the controller controls, when conveying sheets including an unnecessary sheet not to be used for an output object, such that the unnecessary sheet is ejected to the tray to which the remaining sheets are ejected by the purging process.

10. An image forming system comprising:
an image forming section configured to form an image on a sheet;
an ejection section configured to eject the sheet to a plurality of different trays;
a controller configured to control such that the image forming section forms an image on the sheet, and the sheet on which the image is formed in the image forming section is ejected to any of the trays in the ejection section,
wherein the controller controls the ejection section such that when performing a purging process in which remaining sheets remaining in the image forming system are gathered and ejected to any of the trays in the ejection section, any of the trays other than a valid sheet tray which is a tray to which a sheet having a normally formed image has been ejected is set as a purge tray which is a tray to which the remaining sheets are to be ejected in the purging process, and then the remaining sheets are ejected to the purge tray.

11. The image forming system of claim 10, wherein the controller sets a tray which is on the most downstream side in a sheet conveyance direction and to which the remaining sheet can be ejected is set as the purge tray.

12. The image forming system of claim 10, comprising:
a jam detection section configured to detect sheet jam,
wherein the controller detects a position at which sheet jam occurs frequently, based on a history in which detection results of the jam detection section are accumulated, and the controller sets a tray in a vicinity of the detected position as the purge tray.

13. The image forming system of claim 10, wherein the controller sets as the purge tray a tray to which an unnecessary sheet is ejected, wherein the unnecessary sheet is a sheet not to be used as an output object.

14. The image forming system of claim 10, wherein each tray included in the ejection section is equipped with a sensor configured to detect placement of sheet, and when the controller refers to detection results of the sensors and the placement of sheet is detected from a state that a sheet has not been ejected, the controller sets the tray in which the placement of sheet has been detected as the purge tray.

15. The image forming system of claim 10, wherein each tray included in the ejection section is equipped with a sensor configured to detect placement of sheet, and when the controller refers to detection results of the sensors and placement of sheet is detected from a state that a sheet has not been ejected, the controller sets the tray in which the placement of sheet has been detected as the valid sheet tray or the purge tray according to a setting or a selection.

16. The image forming system of claim 10, wherein after ejecting the remaining sheet to the purge tray by the purging process, the controller controls such that the purging process is performed with the purge tray being set as the ejection destination until the remaining sheets ejected in the purge tray are removed.

17. The image forming system of claim 10, wherein after ejecting the remaining sheet to the purge tray by the purging process, the controller controls such that the purging process is performed with the purge tray set as the ejection destination until the power of the image forming system is cut off.

18. The image forming system of claim 10, wherein the controller controls, when conveying sheets including an unnecessary sheet not to be used for an output object, such that the unnecessary sheet is ejected to the tray to which the remaining sheets are ejected by the purging process.

19. A sheet processing control method for controlling a purging process in which remaining sheets remaining in a sheet processing apparatus are gathered and ejected, wherein the sheet processing apparatus includes:
an ejection section configured to eject the sheets to a plurality of different trays; and
a controller configured to control such that the sheets are ejected to any of the trays in the ejection section,
the sheet processing control method comprising:
a step of setting, as a purge tray for the purging process, any of the trays other than a valid sheet tray which is a tray to which a sheet having a normally formed image has been ejected; and
a step of gathering the remaining sheets and ejecting the remaining sheets to the purge tray when the remaining sheets are created.
